(19) United States
(12) Patent Application Publication
(10) Pub. No.: US 2019/0011617 A1
(43) Pub. Date: Jan. 10, 2019

(54) MULTI-FUNCTIONAL HIBRID FILTER

(71) Applicant: MORRISON OPTOELECTRONICS LTD., Hsin Chu Hsien (TW)

(72) Inventors: Wei-Kuo CHENG, Taipei City (TW); Chin-Chen KUO, Hsinchu City (TW); Tsung-Hsiu WU, Zhubei City (TW)

(21) Appl. No.: 15/645,077

(22) Filed: Jul. 10, 2017

(51) Int. Cl. G02B 5/28; G02B 27/00; G02B 5/20

(52) U.S. Cl. CPC G02B 5/281; G02B 5/208; G02B 5/201; G02B 27/0018

(57) ABSTRACT

A multi-functional hybrid filter comprises a transparent substrate having a hybrid light filtering portion and an infrared light filtering portion; wherein, said hybrid light filtering portion is constructed by an infrared light absorbing material layer and a reflective interference type infrared cut filtering layer (IRCF) formed on the surface of said transparent substrate.

### BACKGROUND OF THE INVENTION

### Field of the Invention

The present invention relates to a multi-functional hybrid filter, especially to multi-functional hybrid filter having: a hybrid light filtering portion that prevents from the generation of flare when a visible light in the wavelength of 400 nm˜700 nm injects into the filter with a large injection angel as 30 degrees (30°), and allows the infrared light of wavelength in 850 nm˜940 nm can pass through; and an infrared light filtering portion is formed for infrared light of wavelength in 850 nm˜940 nm to pass through only.

### Description of the Prior Art

It is known to public that a camera lens is constructed by optical lenses, a filter and an image sensor installed inside a lens seat. In view of a digital camera, an infrared cut filter (IRCF) mainly for filtering infrared light is installed inside the camera lens for preventing the infrared light to pass through, thus the color shift phenomenon occurred due to interferences to charge couple device (CCP) or to complementary metal-oxide semiconductor (CMOS) of the image sensor is avoided.

Since the infrared cut filter (IRCF) can not completely separate infrared light, and when a partial infrared light passes through the filter, the phenomena of flare, ghosting etc. still shall be generated. In order to improve such phenomena, the blue glass filter having the function of absorbing infrared was used. However, the conventional blue glass filter is manufactured by adding iron, nickel and other formulations into the glass raw materials to form glass block by melting, then perform the processes of cutting, grinding and polishing to obtain blue glass filter sheet.

A blue glass filter having very thin thickness can not be obtained. Furthermore, the reliabilities of materials for manufacturing blue glass filter are low, thus the properties of blue glass filter are not stable.

In view of the aforementioned shortcomings with regards to the conventional filter, after a long period of research in conjunction with improvement on the aforementioned deficiency, the present invention is eventually presented by the inventor.

### SUMMARY OF THE INVENTION

The object of present invention is mainly to provide a multi-functional hybrid filter having a hybrid light filtering portion and an infrared filtering portion formed on surface of a transparent substrate, such that only the visible light, or both the visible light and infrared light, or only the infrared light can pass through.

According to the multi-functional hybrid filter of present invention, said hybrid light filtering portion is formed with an infrared light absorbing material layer and a reflective interference type infrared cut filter (IRCF), by the design of layers and adjustment of thickness, a visible light of wavelength in 400 nm˜700 nm and an infrared light of wavelength in 850 nm˜940 nm can pass through, it is then suitable to be applied in whole day sensors, this is an another object of present invention.

According to the multi-functional hybrid filter of present invention, said infrared light filtering portion is constructed by an infrared light filtering film partially formed on said hybrid light filtering portion, and only the infrared red of wave-length in 850 nm˜940 nm can pass through, it is then suitable to be applied in sensors for detecting infrared light, this is a further object of present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing the multi-functional hybrid filter of present invention;

FIG. 2 is a cross-sectional view showing the multi-functional hybrid filter of present invention;

FIG. 3 is a diagram showing the characteristics of wavelengths vs. penetration rates of the hybrid light filtering portion of present invention;

FIG. 4 is a diagram showing the characteristics of wavelengths vs. penetration rates of the infrared light filtering portion of present invention;

### DETAILED DESCRIPTION OF THE PREFERRED EMBODIMENTS

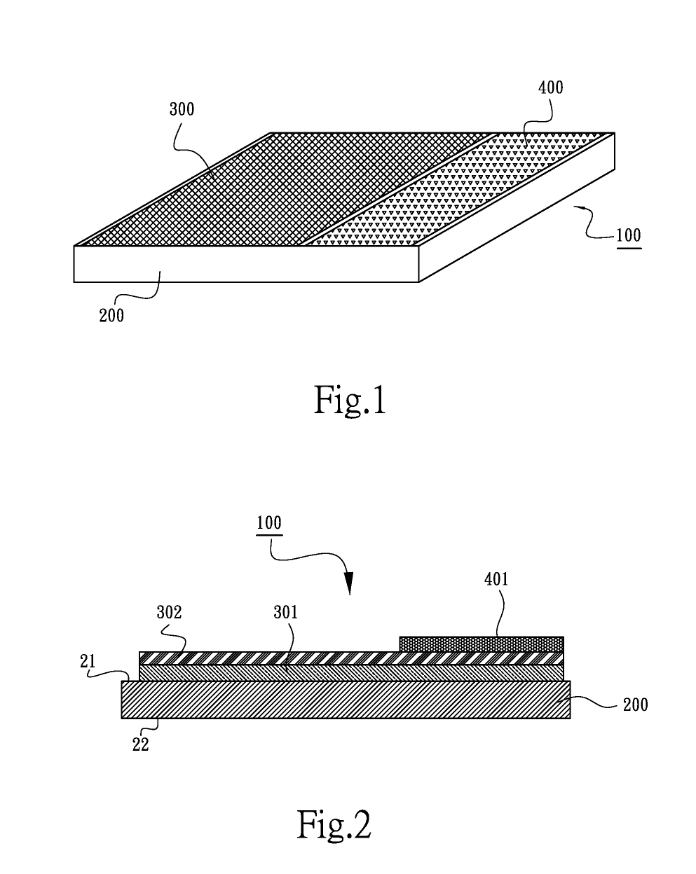

As shown in FIG. 1 and FIG. 2, the multi-functional hybrid filter 100 of present invention is constructed with a transparent substrate 200 having a hybrid light filtering portion 300 and an infrared light filtering portion 400 formed on its surface 21. Said transparent substrate 200 can be a glass substrate or a silicon wafer substrate.

Please refer to FIG. 2, said transparent substrate 200 includes two opposite upper surface 21 and lower surface 22. Wherein on the upper surface 21, an infrared light absorbing materials layer 301 is formed, and a reflective interference type infrared cut filter (IRCF) 302 is formed on said infrared light absorbing material layer 301, thus when a visible light of wavelength in 400 nm˜700 nm injects into the filter with a large injection angel as 30 degrees (30°), the generation of flare around the image sensor of camera lens shall be prevented; furthermore, an infrared light of wavelength in 850 nm˜940 nm injects into the filter with a large injection angel as 30 degrees (30°) can definitely pass through the filter.

Said infrared light absorbing material layer 301 is a blue dye composition including cyclohexanone, expoxy resins, metal-containing pigments, and is capable of absorbing infrared light to reduce the penetration rate of infrared light band. While said reflective interference type infrared cut filter (IRCF) 302 is formed by 5˜100 layers of films having 0.3 μm˜0.7 μm of thickness each.

Said infrared light filtering portion 400 is formed as an infrared light filtering layer (IR) 401 on a portion of the upper surface of said reflective interference type infrared cut filtering layer (IRCF) 302, such that only the infrared light of wavelength 850 nm˜940 nm can pass through said portion 400.

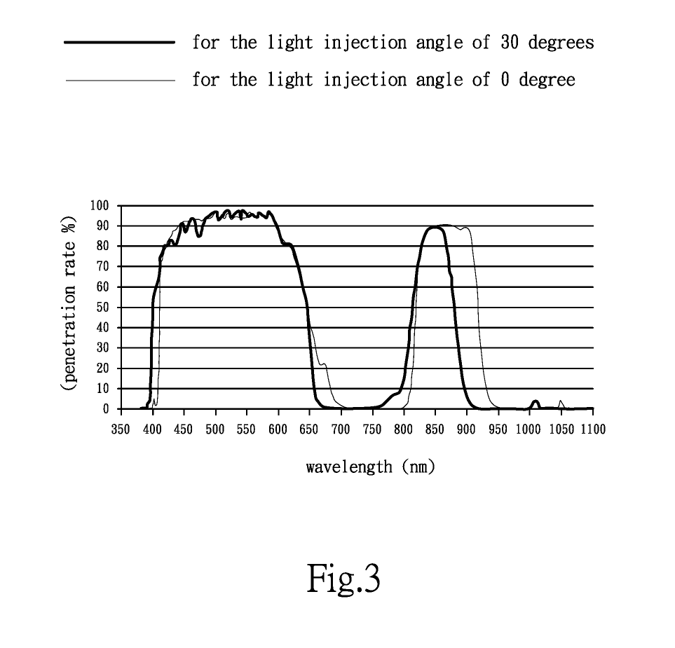

As shown in FIG. 3, by the above stated construction, in the multi-functional hybrid filter of present invention, the area of said hybrid light filtering portion 300 without covered by the infrared light filtering layer (IR) 401, can provide the function of preventing the generation of flare when a visible light of wavelength in 400 nm˜700 nm injects into the filter with a large injection angel as 30 degrees (30°); while an infrared light of wavelength in 850 nm˜940 nm injects into the filter with a lager injection angel as 30 degrees (30°) shall definitely pass through the filter.

Thus the multi-functional hybrid filter of present invention is suitable for application in whole day sensors.

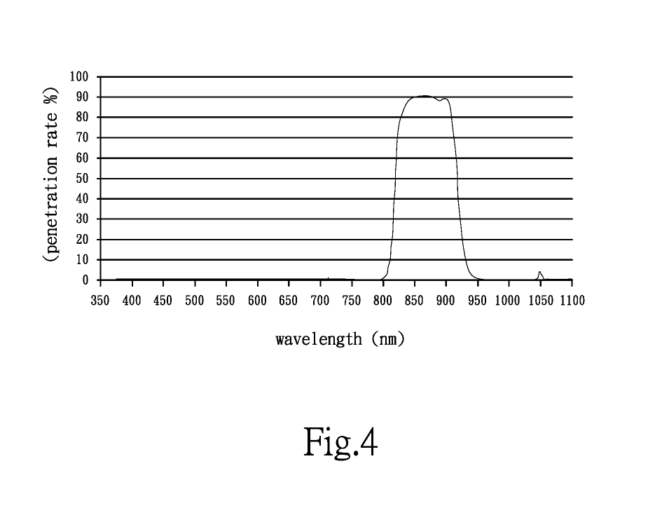

In addition, as shown in FIG. 4, in the multi-functional hybrid filter of present invention, by forming the infrared light filtering layer (IR) 401 onto partial area of the upper surface of said hybrid light filtering portion 300 as infrared light filtering portion 400, then only infrared lights of wavelength in 850 nm˜940 nm can pass through the filter.

Then the multi-functional hybrid filter of present invention is suitable for application in infrared light sensors.

In the multi-functional hybrid filter of present invention, the thickness of said transparent substrate 200 can be as thin as 0.145 mm˜0.3 mm, the thickness of infrared light absorbing material layer 301 can be as thin as 2 μm, while the thickness of said infrared cut filter (IRCF) 302 can be as thin as 0.1 μm˜7 μm, thus the thickness of present invention can be manufactured as thin as possible.

In conclusion from above, the multi-functional hybrid filter of present invention is definitely capable of improving the disadvantages of conventional light filtering element, it does not have been opened or used in public, then it complies conditions of allowable patent.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A multi-functional hybrid filter comprises a transparent substrate having a hybrid light filtering portion and an infrared light filtering portion.

2. The multi-functional hybrid filter as claimed in claim 1, wherein said hybrid light filtering portion is constructed by an infrared light absorbing material layer and a reflective interference type infrared cut filtering layer (IRCF) formed on the surface of said transparent substrate, such that a visible light of wavelength in 400 nm˜700 nm and an infrared light of wavelength in 850 nm˜940 nm can pass through.

3. The multi-functional hybrid filter as claimed in claim 2, wherein said infrared light filtering portion is constructed by an infrared light filtering film partially formed on said hybrid light filtering portion, and only the infrared red of wavelength in 850 nm˜940 nm can pass through said infrared light filtering portion.

4. The multi-functional hybrid filter as claimed in claim 3, wherein said infrared light absorbing material layer is formed of a blue dye composition including cyclohexanone, expoxy resin, metal-containing pigment, and capable of absorbing infrared light, reducing the penetration rate of infrared light band.

5. The multi-functional hybrid filter as claimed in claim 4, wherein said reflective interference type infrared cut filter (IRCF) is formed by 5˜100 layers of films, having 0.3 μm˜0.7 μm of thickness each.
